(19) United States
(12) Patent Application Publication
(10) Pub. No.: US 2018/0283973 A1
(43) Pub. Date: Oct. 4, 2018

(54) SENSOR DEVICE, ELECTRONIC APPARATUS, AND VEHICLE

(71) Applicant: SEIKO EPSON CORPORATION, Tokyo (JP)

(72) Inventors: Ryuichi KUROSAWA, Hara-mura (JP); Akihiro MURATA, Hokuto-shi (JP)

(73) Assignee: SEIKO EPSON CORPORATION, Tokyo (JP)

(21) Appl. No.: 15/919,618

(22) Filed: Mar. 13, 2018

(30) Foreign Application Priority Data
Mar. 28, 2017 (JP) 2017-062674

(51) Int. Cl. G01L 19/02; G01L 9/00; G01L 13/02

(52) U.S. Cl. CPC G01L 19/02; G01L 9/0052; G01L 13/026; G01L 9/0048

(57) ABSTRACT

A sensor device includes a pressure sensor including a first diaphragm, and a pressure reference chamber which is positioned on a side opposite to the pressure receiving surface with respect to the first diaphragm and measuring pressure received by the pressure receiving surface, a differential pressure sensor including a second diaphragm which is bent and deformed by pressure reception and of which one surface is a first pressure receiving surface and the other surface is a second pressure receiving surface and measuring differential pressure which is a difference between pressure received by the first pressure receiving surface and pressure received by the second pressure receiving surface, and a correction unit correcting an output of one of the pressure sensor and the differential pressure sensor based on an output of the other of the pressure sensor and the differential pressure sensor.

### BACKGROUND

### 1. Technical Field

The present invention relates to a sensor device, an electronic apparatus, and a vehicle.

### 2. Related Art

In the related art, as a pressure sensor, for example, a configuration described in JP-A-9-126920 is known. The pressure sensor of JP-A-9-126920 includes a sensor body, a case for housing the sensor body, and an inert liquid filled in the case. The sensor body includes a diaphragm bent and deformed by pressure reception, a piezoresistive element formed on the diaphragm, and a pressure reference chamber disposed so as to overlap the diaphragm. Such a pressure sensor is configured in such a way that the diaphragm bends and deforms by pressure transmitted through the inert liquid and pressure is detected utilizing the fact that a resistance value of the piezoresistive element changes based on the bending deformation.

However, in the pressure sensor of JP-A-9-126920, for example, when it is attempted to detect pressure in a state where acceleration is applied, the diaphragm bends and deforms not only by pressure to be detected but also by acceleration and thus, pressure cannot be detected accurately.

### SUMMARY

An advantage of some aspects of the invention is to provide a sensor device having excellent detection accuracy, an electronic apparatus, and a vehicle.

The advantage described above can be achieved by the following configurations.

A sensor device according to an aspect of the invention includes a pressure sensor including a first diaphragm, which is bent and deformed by pressure reception and of which one surface is a pressure receiving surface, and a pressure reference chamber which is positioned on a side opposite to the pressure receiving surface with respect to the first diaphragm and measuring pressure received by the pressure receiving surface; a differential pressure sensor including a second diaphragm which is bent and deformed by pressure reception and of which one surface is a first pressure receiving surface and the other surface is a second pressure receiving surface and measuring differential pressure which is a difference between pressure received by the first pressure receiving surface and pressure received by the second pressure receiving surface; and a correction unit correcting an output of one of the pressure sensor and the differential pressure sensor based on an output of the other of the pressure sensor and the differential pressure sensor.

With this configuration, it is possible to cancel acceleration, vibration, and the like applied to the sensor device and obtain a sensor device having excellent detection accuracy.

In the sensor device according to the aspect of the invention, it is preferable that the correction unit corrects the output of the pressure sensor based on the output of the differential pressure sensor.

With this configuration, it is possible to accurately detect the pressure.

In the sensor device according to the aspect of the invention, it is preferable that the correction unit corrects the output of the differential pressure sensor based on the output of the pressure sensor.

With this configuration, it is possible to accurately detect the differential pressure.

In the sensor device according to the aspect of the invention, it is preferable that the first diaphragm and the second diaphragm are oriented in the same direction.

With this configuration, unnecessary stress such as gravity and acceleration acts substantially equally on the first diaphragm and the second diaphragm. For that reason, it is possible to more accurately cancel the acceleration, vibration, and the like applied to the sensor device.

It is preferable that the sensor device according to the aspect of the invention further includes a substrate and the first diaphragm and the second diaphragm are provided on the substrate.

With this configuration, a device configuration becomes simple.

It is preferable that the sensor device according to the aspect of the invention further includes a pressure propagation portion covering the first diaphragm and the second diaphragm.

With this configuration, it is possible to protect the first diaphragm and the second diaphragm.

An electronic apparatus according to an aspect of the invention includes the sensor device according to the aspect of the invention.

With this configuration, it is possible to obtain effects of the sensor device according to the aspect of the invention and to obtain a highly reliable electronic apparatus.

A vehicle according to an aspect of the invention includes the sensor device according to the aspect of the invention.

With this configuration, it is possible to obtain effects of the sensor device according to the aspect of the invention and to obtain a highly reliable vehicle.

### BRIEF DESCRIPTION OF THE DRAWINGS

The invention will be described with reference to the accompanying drawings, wherein like numbers reference like elements.

FIG. 1 is a cross-sectional view illustrating a sensor device according to a first embodiment of the invention.

FIG. 2 is a plan view illustrating a first sensor unit included in the sensor device illustrated in FIG. 1.

FIG. 3 is a circuit diagram illustrating a bridge circuit including the first sensor unit illustrated in FIG. 2.

FIG. 4 is a plan view illustrating a second sensor unit included in the sensor device illustrated in FIG. 1.

FIG. 5 is a circuit diagram illustrating a bridge circuit including the second sensor unit illustrated in FIG. 4.

FIG. 6 is a cross-sectional view illustrating a sensor device according to a second embodiment of the invention.

FIG. 7 is a cross-sectional view illustrating an attached state of the sensor device illustrated in FIG. 6.

FIG. 8 is a cross-sectional view illustrating a sensor device according to a third embodiment of the invention.

FIG. 9 is a cross-sectional view illustrating an attached state of the sensor device illustrated in FIG. 8.

FIG. 10 is a perspective view illustrating an altimeter as an electronic apparatus according to a fourth embodiment of the invention.

FIG. 11 is a front view illustrating a navigation system as an electronic apparatus according to a fifth embodiment of the invention.

FIG. 12 is a perspective view illustrating an automobile as a vehicle according to a sixth embodiment of the invention.

### DESCRIPTION OF EXEMPLARY EMBODIMENTS

In the following, a sensor device, an electronic apparatus, and a vehicle of the invention will be described in detail based on embodiments illustrated in the accompanying drawings.

### First Embodiment

First, a sensor device according to a first embodiment of the invention will be described.

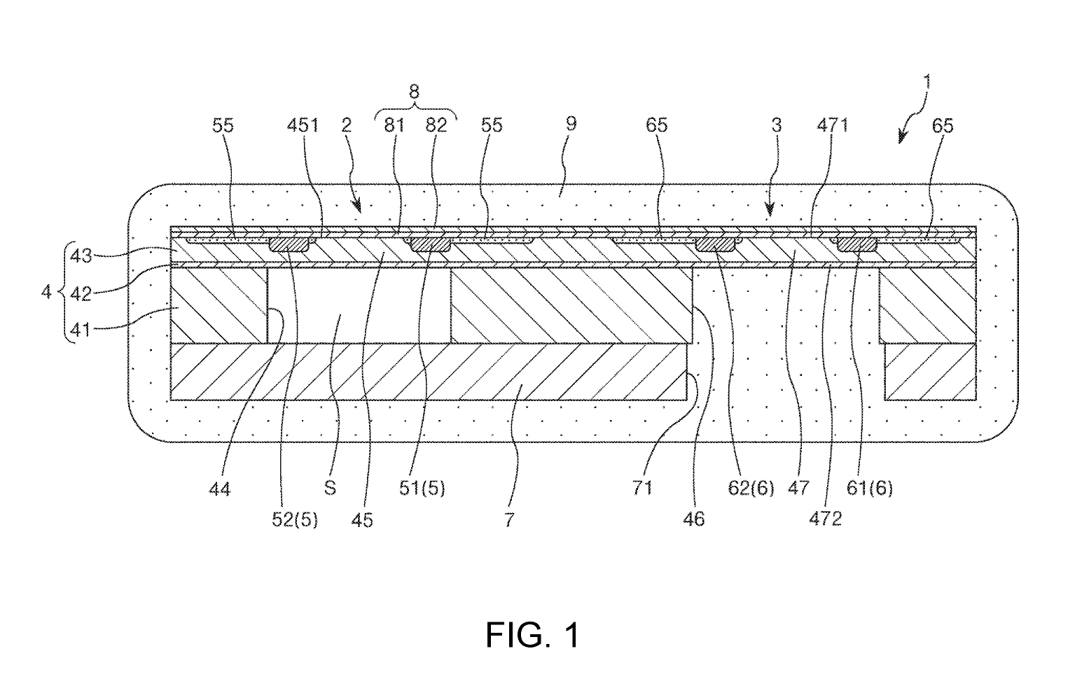

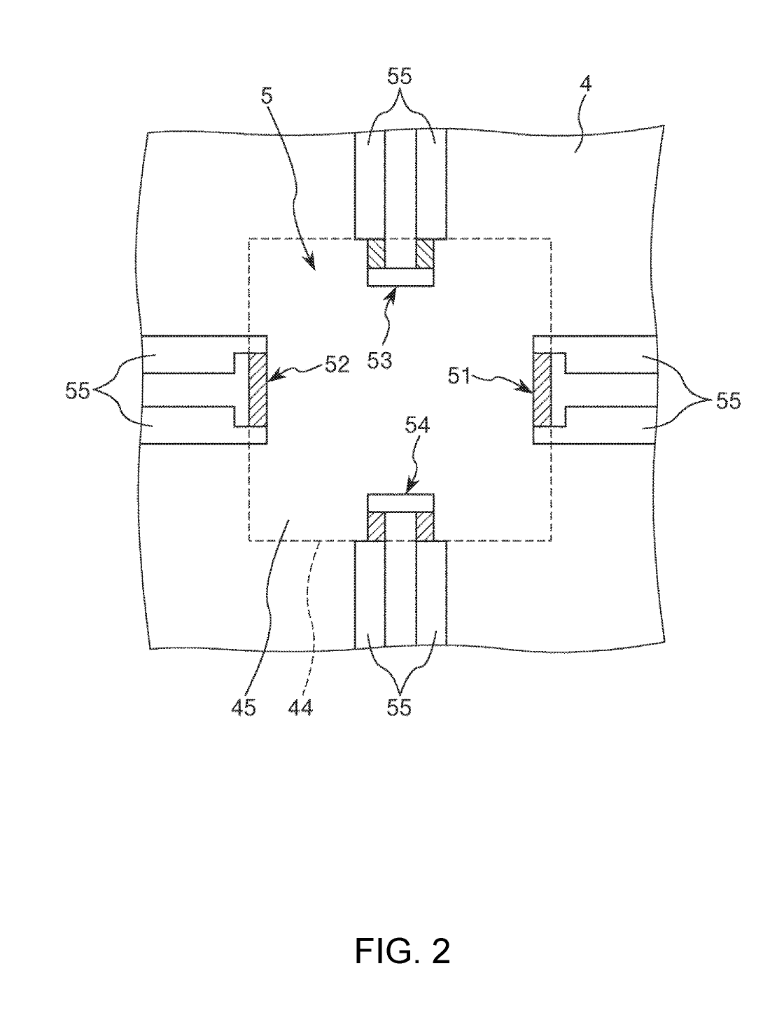

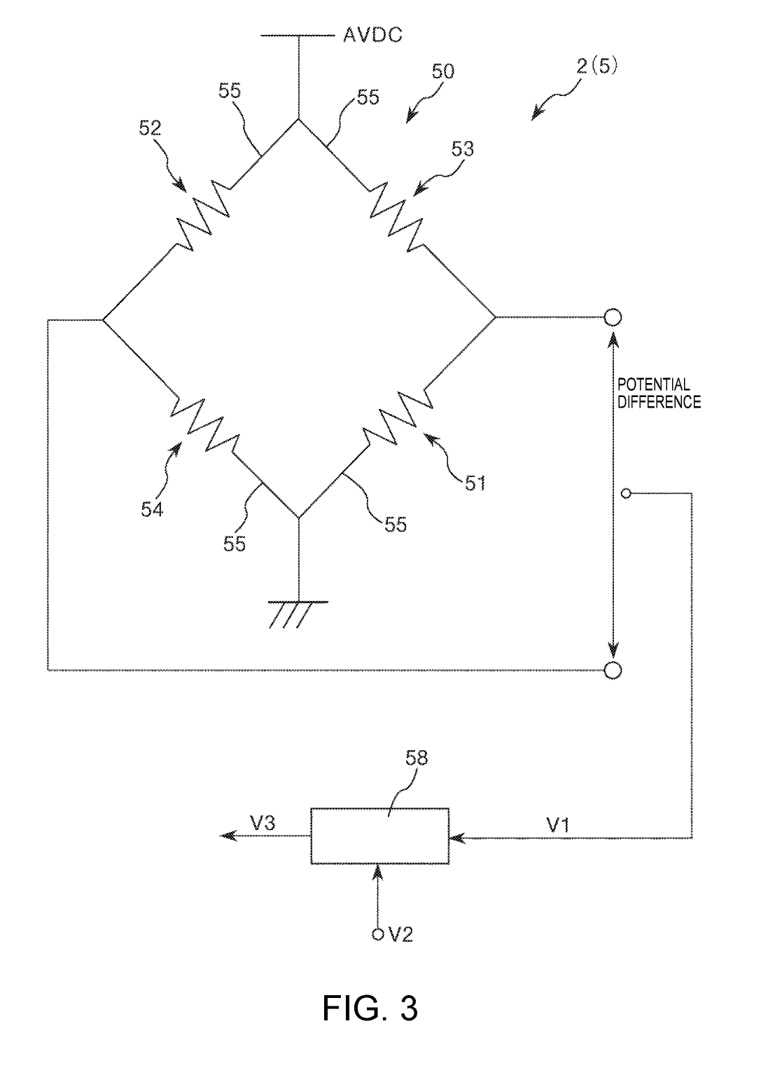

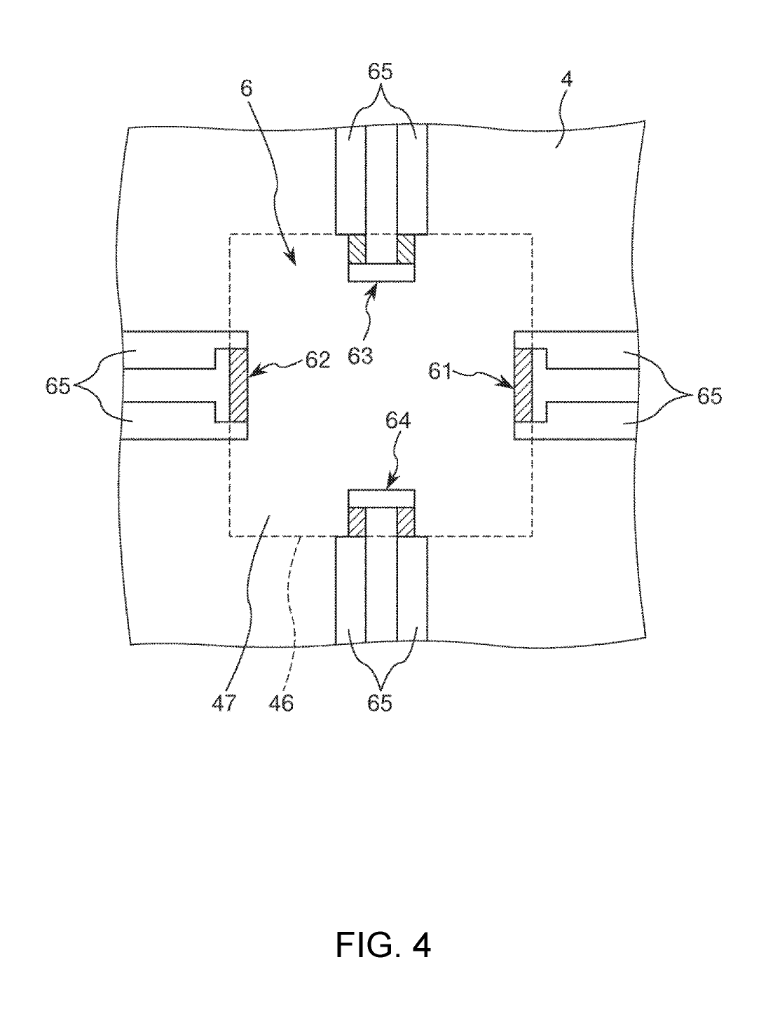

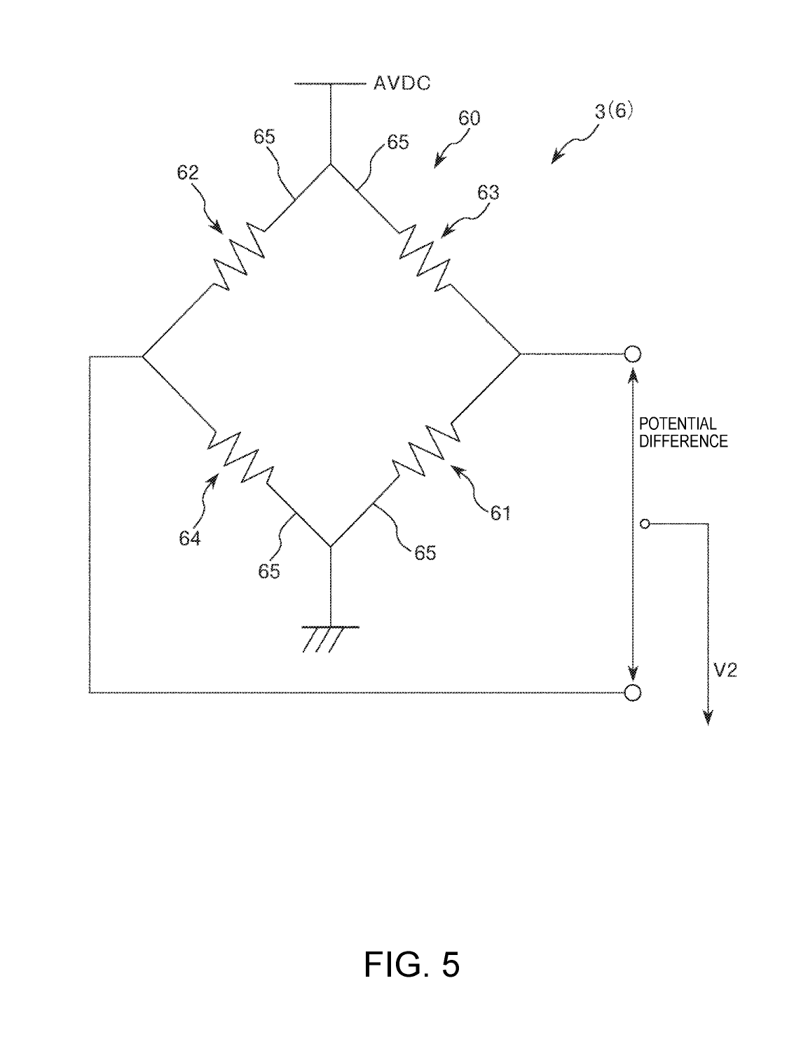

FIG. 1 is a cross-sectional view illustrating a sensor device according to a first embodiment of the invention. FIG. 2 is a plan view illustrating a first sensor unit included in the sensor device illustrated in FIG. 1. FIG. 3 is a circuit diagram illustrating a bridge circuit including the first sensor unit illustrated in FIG. 2. FIG. 4 is a plan view illustrating a second sensor unit included in the sensor device illustrated in FIG. 1. FIG. 5 is a circuit diagram illustrating a bridge circuit including the second sensor unit illustrated in FIG. 4. In the following description, the upper side in FIG. 1 is also referred to as “above” and the lower side is referred to as “below”.

As illustrated in FIG. 1, a sensor device 1 includes a pressure sensor 2, a differential pressure sensor 3, and a pressure propagation portion 9 covering the sensors. The pressure sensor 2 includes a first diaphragm 45, a first sensor unit 5 disposed on the first diaphragm 45, and a pressure reference chamber S provided on the lower side of the first diaphragm 45. On the other hand, the differential pressure sensor 3 includes a second diaphragm 47 and a second sensor unit 6 disposed on the second diaphragm 47. The pressure sensor 2 and the differential pressure sensor 3 are integrally formed from a stacked body of a substrate 4 and a base substrate 7 as will be described later.

As illustrated in FIG. 3, the sensor device 1 includes a correction unit 58 (correction circuit) that corrects an output of one of the pressure sensor 2 and the differential pressure sensor 3 based on an output of the other of the pressure sensor 2 and the differential pressure sensor 3. In particular, in the first embodiment, the correction unit 58 corrects the output of the pressure sensor 2 based on the output of the differential pressure sensor 3. With this, it is possible to cancel acceleration, vibration, and the like applied to the sensor device 1 and to more accurately detect pressure. The correction unit 58 may be included in the pressure sensor 2 or the differential pressure sensor 3, that is, may be built in the substrate 4, or may be disposed separately from the pressure sensor 2 and the differential pressure sensor 3. In the following, such a sensor device 1 will be described in detail.

As illustrated in FIG. 1, the pressure sensor 2 and the differential pressure sensor 3 have the common substrate 4. The substrate 4 is an SOI substrate in which a first silicon layer 41, a silicon oxide layer 42, and a second silicon layer 43 are stacked in this order. However, the substrate 4 is not limited to the SOI substrate, and for example, a single layer silicon substrate may be used as the substrate 4. As the substrate 4, a substrate (semiconductor substrate) made of a semiconductor material other than silicon, for example, germanium, gallium arsenide, gallium arsenide phosphorus, gallium nitride, silicon carbide, or the like may be used.

The substrate 4 is provided with the first diaphragm 45 and the second diaphragm 47 which are thinner than a peripheral portion, bent and deformed by pressure reception and are aligned in the lateral direction (plane direction) in FIG. 1.

A recess portion 44 that has a bottom and opens downward is formed in the substrate 4 and an upper side of the recess portion 44 (portion where the substrate 4 is thinned by the recess portion 44) is the first diaphragm 45. In the first diaphragm 45, the upper surface thereof is a pressure receiving surface 451. Similarly, a recess portion 46 that has a bottom and opens downward is formed in the substrate 4 and the upper side of the recess portion 46 (portion where the substrate 4 is thinned by the recess portion 46) is the second diaphragm 47. In the second diaphragm 47, both main surfaces thereof are pressure receiving surfaces 471 and 472.

As such, the first diaphragm 45 and the second diaphragm 47 are formed from the same substrate 4 so as to make it possible to simplify a configuration of the sensor device and reduce the size of the sensor device 1. Physical characteristics (bendability, internal stress, and the like) of the first diaphragm 45 and the second diaphragm 47 can be easily aligned.

The recess portions 44 and 46 are formed by dry etching using a silicon deep etching apparatus. Specifically, the recess portions are formed by digging the first silicon layer 41 by repeating processes such as isotropic etching, film-forming of a protective film, and anisotropic etching from the lower surface side of the substrate 4. When the processes are repeated and etching reaches the silicon oxide layer 42, the silicon oxide layer 42 serves as an etching stopper and the etching is ended, and the recess portions 44 and 46 are obtained. According to such a forming method, side surfaces of the recess portions 44 and 46 are substantially perpendicular to the main surface of the substrate 4 and thus, an opening area of the recess portions 44 and 46 can be reduced. For that reason, it is possible to suppress reduction in mechanical strength of the substrate 4 and to suppress an increase in size of the sensor device 1.

However, a method of forming the recess portions 44 and 46 is not limited to the method described above, and the recess portions 44 and 46 may be formed by, for example, wet etching. In the first embodiment, the silicon oxide layer 42 is left in each of the first diaphragm 45 and the second diaphragm 47, but the silicon oxide layer 42 may be further removed. That is, the first diaphragm 45 and the second diaphragm 47 may be formed of a single layer of the second silicon layer 43. With this, the first diaphragm 45 and the second diaphragm 47 become thinner and more easily bent and deformed. In a case where each of the first diaphragm 45 and the second diaphragm 47 is formed of a plurality of layers (silicon oxide layer 42 and second silicon layer 43) as in the first embodiment, there is a concern that thermal stress occurs due to the difference in the thermal expansion coefficient of each layer, and the first diaphragm 45 and the second diaphragm 47 are unintentionally bent and deformed, that is, bent and deformed due to force other than the pressure to be detected. In contrast, each of the first diaphragm 45 and the second diaphragm 47 is formed of a single layer and accordingly, there is a merit that thermal stress as described above does not occur and thus, the pressure to be detected can be more accurately detected.

In the first embodiment, the first diaphragm 45 and the second diaphragm 47 are formed to have the same shape and size. Each of the first diaphragm 45 and the second diaphragm 47 has a substantially square as a plan view shape. Here, the “same shape and size” means that in addition to a case where both the shape and size are completely identical, a case where at least one of the shape and the size differs to an inevitable extent in manufacturing is also included.

The shapes and sizes of the first diaphragm 45 and the second diaphragm 47 are not particularly limited, and may have, for example, similar shapes having the same shape in plan view but having different sizes, and the plan view shapes different from each other. The plan view shapes of the first diaphragm 45 and the second diaphragm 47 are not particularly limited, but may include a shape having a corner portion such as a triangle, or a polygon having a pentagon or more, or a shape without a corner portion such as a circle, an ellipse, or an oval. In a case where the plan view shape has a corner portion, the corner portion may be chamfered.

As illustrated in FIG. 1, the base substrate 7 is disposed under the substrate 4. The base substrate 7 is joined to the lower surface of the substrate 4 so as to close an opening of the recess portion 44 and form the pressure reference chamber S (airtight space) between the base substrate 7 and the first diaphragm 45. The base substrate 7 has a through-hole 71 which communicates inside and outside of the recess portion 46 so as not to close the opening of the recess portion 46. With such a configuration, it is possible to cause the first diaphragm 45 to be bent and deformed based on a difference (absolute pressure) between pressure in the pressure reference chamber S and pressure received by the pressure receiving surface 451 and to cause the second diaphragm 47 to be bent and deformed based on a difference (differential pressure) between pressure received by the pressure receiving surface 471 and pressure received by the pressure receiving surface 472. The base substrate 7 is not particularly limited, and for example, a silicon substrate, a glass substrate, a ceramic substrate, or the like can be used as the base substrate 7.

Here, the pressure reference chamber S is preferably in a vacuum state. With this, the pressure sensor 2 can be used as an absolute pressure sensor for measuring pressure by using the vacuum as a reference. For that reason, the pressure sensor 2 becomes a highly reliable pressure sensor. However, pressure in the pressure reference chamber S is not particularly limited and the pressure may not be a vacuum.

As illustrated in FIG. 2, the first diaphragm 45 is provided with the first sensor unit 5 that detects pressure acting on the first diaphragm 45. The first sensor unit 5 includes four piezoresistive elements 51, 52, 53, and 54 provided on the first diaphragm 45. The piezoresistive elements 51, 52, 53, and 54 are electrically connected to each other via wirings 55 and constitute a bridge circuit 50 (wheatstone bridge circuit) illustrated in FIG. 3. A drive circuit (not illustrated) that supplies a drive voltage AVDC is connected to the bridge circuit 50. Then, the bridge circuit 50 outputs a detected signal (voltage) V1 in accordance with change in the resistance value of the piezoresistive elements 51, 52, 53, and 54 based on bending of the first diaphragm 45. For that reason, it is possible to detect pressure received by the first diaphragm 45 based on the detected signal V1 output from the bridge circuit 50.

On the other hand, as illustrated in FIG. 4, the second diaphragm 47 is provided with the second sensor unit that detects differential pressure (difference between pressure received by the pressure receiving surface 471 and pressure received by the pressure receiving surface 472) acting on the second diaphragm 47. The second sensor unit 6 has the same configuration as that of the first sensor unit 5. That is, the second sensor unit 6 includes four piezoresistive elements 61, 62, 63, and 64 provided on the second diaphragm 47 and the piezoresistive elements 61, 62, 63, and 64 are electrically connected to each other via wirings 65 and constitute a bridge circuit 60 (wheatstone bridge circuit) of the second sensor unit 6 illustrated in FIG. 5. A drive circuit (not illustrated) for supplying the drive voltage AVDC is connected to the bridge circuit 60. The bridge circuit 60 outputs a detected signal V2 (voltage) in accordance with change in the resistance value of the piezoresistive elements 61, 62, 63, and 64 based on bending of the second diaphragm 47. For that reason, it is possible to detect the differential pressure received by the second diaphragm 47 based on the detected signal V2 output from the bridge circuit 60.

As illustrated in FIGS. 3 and 5, output terminals of the pressure sensor 2 (first sensor unit 5) and the differential pressure sensor 3 (second sensor unit 6) are connected to the correction unit 58, respectively, and the correction unit 58 corrects the detected signal V1 output from the pressure sensor 2 based on the detected signal V2 output from the differential pressure sensor 3 and outputs a corrected signal V3.

The piezoresistive elements 51, 52, 53, 54, 61, 62, 63, and 64 are formed by doping (diffusing or injecting) impurities such as phosphorus and boron into the second silicon layer 43 of the substrate 4. The wirings 55 and 65 are formed, for example, by doping (diffusing or injecting) impurities such as phosphorus and boron into the second silicon layer 43 of the substrate 4 at a higher concentration than that of the piezoresistive elements 51, 52, 53, 54, 61, 62, 63, and 64. However, the forming methods of the piezoresistive elements 51, 52, 53, 54, 61, 62, 63, and 64 and the wirings 55 and 65 are not particularly limited.

As illustrated in FIG. 1, a protective film 8 is disposed on the upper surface of the substrate 4. The protective film 8 includes a first insulating film 81 disposed on the upper surface of the substrate 4 and a second insulating film 82 disposed on the first insulating film 81. The first insulating film 81 is formed of a silicon oxide film (SiO₂ film). With this, it is possible for the first insulating film 81 to reduce an interface level of the piezoresistive elements 51, 52, 53, 54, 61, 62, 63, and 64 and suppress generation of noise. On the other hand, the second insulating film 82 is formed of a silicon nitride film (SiNₓ film). With this, it is possible to protect the first sensor unit 5 and the second sensor unit 6 from moisture and dust and to enhance reliability of the sensor device 1. The configuration of the protective film 8 is not particularly limited and, for example, a configuration in which at least one of the first insulating film 81 and the second insulating film 82 is omitted in the protective film 8 or the insulating films 81 and 82 are made of a different material may be available.

### Pressure Propagation Portion

As illustrated in FIG. 1, the pressure propagation portion 9 is provided so as to cover the pressure sensor 2 and the differential pressure sensor 3. With this, it is possible to protect the pressure sensor 2 and the differential pressure sensor 3 from moisture. It is possible to impart waterproof property to the sensor device 1. Such a pressure propagation portion 9 can be formed of a liquid or gel filler. The filler forming the pressure propagation portion 9 is not particularly limited, and for example, silicone oil, fluorine-based oil, silicone gel, grease, or the like can be used. However, all or a portion of the pressure propagation portion 9 may be omitted. For example, the pressure propagation portion 9 can be omitted for all or a portion of a space formed by the recess portion 46 and the through-hole 71 subsequent to the recess portion 46.

The configuration of the sensor device 1 has been described as above. The sensor device 1 described as above can be used as a pressure sensor for measuring pressure. As described above, in the pressure sensor 2, the first diaphragm 45 is bent and deformed according to pressure received by the pressure receiving surface 451 so that it is possible to detect the pressure received by the pressure receiving surface 451 based on the detected signal output from the bridge circuit 50.

However, for example, the first diaphragm 45 is bent and deformed also by an external force (hereinafter, also referred to as “unnecessary external force”) other than the pressure such as a self-weight, acceleration, or atmospheric fluctuation and thus, the component of unnecessary external force is included in the detected signal output from the bridge circuit 50, in addition to pressure. For that reason, the pressure cannot be accurately detected by the detected signal output from the bridge circuit 50. Accordingly, in the sensor device 1, the second diaphragm 47 for measuring unnecessary external force acting on the first diaphragm 45 is provided.

The pressure receiving surfaces 471 and 472 face the same space and thus, the second diaphragm 47 is not bent and deformed due to pressure, but the second diaphragm 47 bends and deforms in the same manner as the first diaphragm 45 due to unnecessary external force. In particular, the first diaphragm 45 and the second diaphragm 47 are formed from the same substrate 4 and thus, bending deformation due to unnecessary external force has a high degree of approximation. For that reason, the detected signal V2 in accordance with the unnecessary external force received by the second diaphragm 47 is output from the bridge circuit 60 and the detected signal V2 can be regarded as unnecessary external force received by the first diaphragm 45. Accordingly, the sensor device 1 corrects the output value (detected signal V1) of the pressure sensor 2 by the correction unit 58 based on the output value (detected signal V2) of the differential pressure sensor 3 so as to make it possible to cancel the component of unnecessary external force from the output of the pressure sensor 2 by using the corrected signal V3 (corrected signal) and detect pressure more accurately.

Here, the correction unit 58 can obtain the signal V3 by performing computation on, for example, the output value of the pressure sensor 2 and the output value of the differential pressure sensor 3. More specifically, for example, an output value of the differential pressure sensor 3 can be subtracted from the output value of the pressure sensor 2, and in a state of including a table corresponding to the output values of the differential pressure sensor 3, a correction coefficient selected from the table can be integrated to the output of the pressure sensor 2, subtracted from the output of the pressure sensor 2, or the like. However, the computation to be performed by the correction unit 58 is not particularly limited.

Description has been made in such a way that the correction unit 58 corrects the detected signal V1 based on the detected signal V2, but is not limited thereto, and the correction unit 58 may correct the detected signal V2 based on the detected signal V1.

Such a sensor device 1 can exhibit effects more remarkably, for example, in an environment in which a posture (inclination with respect to the vertical direction) of the sensor device 1, such as a vehicle, such as an automobile or an airplane, or a robot having a rotatable arm, is liable to change and the sensor device 1 is susceptible to acceleration and vibration.

In particular, in the first embodiment, as described above, the first diaphragm 45 and the second diaphragm 47 are formed from the same substrate 4 and thus, the first and second diaphragms 45 and 47 are oriented in the same direction. In other words, the thickness directions (normal lines) of the first diaphragm 45 and the second diaphragm 47 are coincident. For that reason, unnecessary stress such as gravity and acceleration acts substantially equally on the first diaphragm 45 and the second diaphragm 47. With this, magnitude of the unnecessary external force received by the pressure sensor 2 can be more accurately detected by the differential pressure sensor 3. Accordingly, the output (detected signal V1) of the pressure sensor 2 is corrected based on the output (detected signal V2) of the differential pressure sensor 3 so as to make it possible to more effectively cancel the unnecessary external force component from the output of the pressure sensor 2. The “same direction” described above means not only a case where the directions (normal directions) are perfectly coincident but also a case where the direction (normal direction) deviates to an extent of error inevitably occurring in manufacturing (for example, an error due to warping of the substrate 4).

In the first embodiment, as described above, the first diaphragm 45 and the second diaphragm 47 are formed from the same substrate 4 and thus, the first diaphragm 45 and the second diaphragm 47 can be provided closer to each other. For that reason, unnecessary stress such as gravity and acceleration acts substantially equally on the first diaphragm 45 and the second diaphragm 47. With this, magnitude of the unnecessary external force received by the pressure sensor 2 is more accurately detected from the differential pressure sensor 3. Accordingly, the output (detected signal) of the pressure sensor 2 is corrected based on the output (detected signal) of the differential pressure sensor 3 so as to make it possible to more effectively cancel the unnecessary external force component from the output of the pressure sensor 2.

In the first embodiment, as described above, the first diaphragm 45 and the second diaphragm 47 have substantially the same configuration. Specifically, the first diaphragm 45 and the second diaphragm 47 have substantially the same plan view shape, have substantially the same size and substantially the same thickness, and both the first diaphragm 45 and the second diaphragm 47 are respectively configured with a stacked body of the silicon oxide layer 42 and the second silicon layer 43. For that reason, the first diaphragm 45 and the second diaphragm 47 have substantially the same physical characteristics such as flexibility. Accordingly, unnecessary stress such as gravity, and acceleration acts substantially equally on the first diaphragm 45 and the second diaphragm 47. With this, the magnitude of the unnecessary external force received by the pressure sensor 2 is more accurately detected from the differential pressure sensor 3. Accordingly, the output (detected signal) of the pressure sensor 2 is corrected based on the output (detected signal) of the differential pressure sensor 3 so as to make it possible to more effectively cancel the unnecessary external force component from the output of the pressure sensor 2.

The sensor device 1 has been described as above. The sensor device 1 described above includes the pressure sensor 2 including the first diaphragm 45, which is bent and deformed by pressure reception and of which an upper surface (one surface) is the pressure receiving surface 451, and the pressure reference chamber S positioned on a lower surface (surface opposite to the pressure receiving surface 451) side with respect to the first diaphragm 45 and measuring the pressure received by the pressure receiving surface 451, the differential pressure sensor 3 which includes the second diaphragm 47 which is bent and deformed by pressure reception and of which an upper surface (one surface) is the pressure receiving surface 471 (first pressure receiving surface) and a lower surface (the other surface) is the pressure receiving surface 472 (second pressure receiving surface) and detects differential pressure which is the difference between the pressure received by the pressure receiving surface 471 and the pressure received by the pressure receiving surface 472, and the correction unit 58 for correcting the output of one of the pressure sensor 2 and the differential pressure sensor 3 based on the output of the other of the pressure sensor 2 and the differential pressure sensor 3. In particular, in the first embodiment, the correction unit 58 is configured to correct the output (detected signal V1) of the pressure sensor 2 based on the output (detected signal V2) of the differential pressure sensor 3. With this, it is possible to cancel acceleration, vibration, and the like applied to the sensor device 1 and to detect pressure more accurately. Accordingly, the sensor device 1 having excellent detection accuracy can be obtained.

As described above, in the sensor device 1, the first diaphragm 45 and the second diaphragm 47 are oriented in the same direction. For that reason, unnecessary stress such as gravity and acceleration acts substantially equally on the first diaphragm 45 and the second diaphragm 47. With this, the magnitude of the unnecessary external force received by the pressure sensor 2 can be more accurately detected by the differential pressure sensor 3. Accordingly, the output (detected signal) of the pressure sensor 2 is corrected based on the output (detected signal) of the differential pressure sensor 3 so as to make it possible to more effectively cancel the unnecessary external force component from the output of the pressure sensor 2.

As described above, the sensor device 1 includes the substrate 4, and the first diaphragm 45 and the second diaphragm are provided on the substrate 4. That is, the first diaphragm 45 and the second diaphragm 47 are formed from the same substrate 4. With this, the first diaphragm 45 and the second diaphragm 47 can be provided closer to each other. For that reason, unnecessary stress such as gravity and acceleration acts substantially equally on the first diaphragm 45 and the second diaphragm 47. It is possible to reduce temperature difference between the first diaphragm 45 and the second diaphragm 47. With this, it is possible to more accurately detect the magnitude of the unnecessary external force received by the pressure sensor 2 from the differential pressure sensor 3. Accordingly, the output (detected signal) of the pressure sensor 2 is corrected based on the output (detected signal) of the differential pressure sensor 3 so as to make it possible to more effectively cancel the unnecessary external force component from the output of the pressure sensor 2.

As described above, the sensor device 1 has the pressure propagation portion 9 that covers the first diaphragm 45 and the second diaphragm 47. With this, it is possible to protect the first diaphragm 45 and the second diaphragm 47 from moisture. It is possible to impart waterproof property to the sensor device 1.

### Second Embodiment

Next, a sensor device according to a second embodiment of the invention will be described.

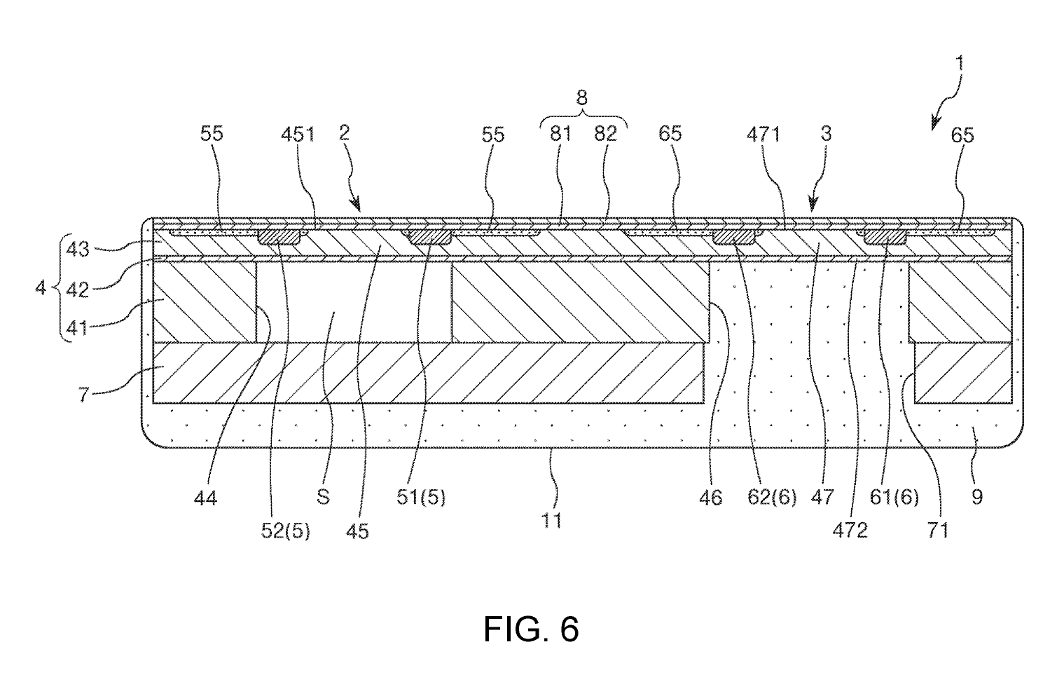

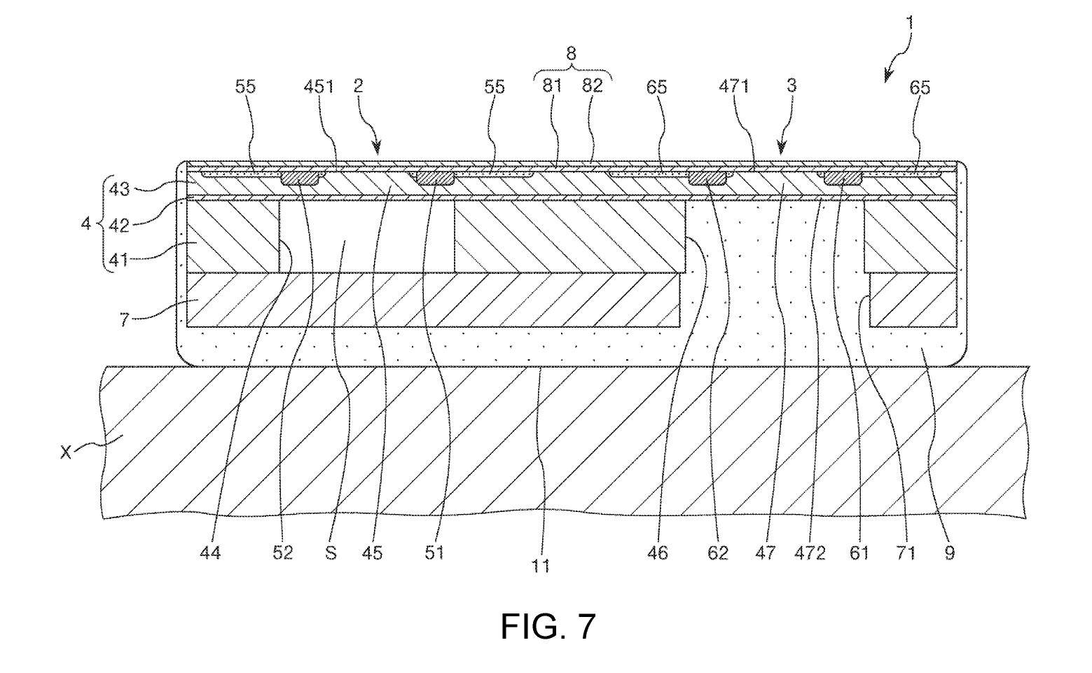

FIG. 6 is a cross-sectional view illustrating the sensor device according to the second embodiment of the invention. FIG. 7 is a cross-sectional view illustrating an attached state of the sensor device illustrated in FIG. 6.

In the following, description will be mainly made on the difference between the sensor device of the second embodiment and the embodiment described above, and description of similar matters will be omitted.

The sensor device 1 according to the second embodiment of the invention is substantially the same as the first embodiment described above except that the configuration of the pressure propagation portion 9 is different. In FIG. 6 and FIG. 7, the same reference numerals are given to the same configurations as in the embodiment described above.

As illustrated in FIG. 6, in the sensor device 1 of the second embodiment, the pressure propagation portion 9 is disposed so as to cover the pressure receiving surface 472 of the second diaphragm 47 and so as not to cover the pressure receiving surface 451 of the first diaphragm 45 and the pressure receiving surface 471 of the second diaphragm 47. In the second embodiment, the pressure propagation portion 9 is filled in the recess portion 46, further protrudes from the recess portion 46, and is disposed so as to spread to a lower surface 11 and the side surface of the sensor device 1. However, disposition of the pressure propagation portion 9 is not particularly limited and for example, the pressure propagation portion 9 may not spread to the side face of the sensor device 1. The pressure propagation portion 9 has a function of transmitting impact (pressure) applied to the lower surface 11 of the sensor device 1 to the pressure receiving surface 472. That is, the impact (pressure) applied to the lower surface 11 of the sensor device 1 is transmitted to the pressure receiving surface 472 via the pressure propagation portion 9.

The constituent materials of such a pressure propagation portion 9 are not particularly limited, and includes various thermoplastic elastomers, for example, a polyurethane-based elastomer, a styrene-based thermoplastic elastomer, an olefin-based thermoplastic elastomer, a vinyl chloride-based thermoplastic elastomer, an ester-based thermoplastic elastomer, an amide-based thermoplastic elastomer, a silicone-based thermoplastic elastomer, a fluorine-based thermoplastic elastomer, and the like and various rubber materials such as acrylic rubber, silicone-based rubber, butadiene-based rubber, and styrene-based rubber, and one or two or more kinds of the thermoplastic elastomers and rubber materials can be used in combination. Such a material having elasticity is used so as to make it possible to effectively transmit the impact (pressure) applied to the lower surface 11 to the pressure receiving surface 472 without hindering bending deformation of the second diaphragm 47.

The sensor device 1 described above can be used as an impact sensor for detecting an impact applied to the sensor device 1. For example, as illustrated in FIG. 7, when an impact is applied to an object X in a state where the sensor device 1 is fixed to the object X such that the lower surface 11 is in contact with the object X side, the impact is transmitted to the pressure receiving surface 472 via the pressure propagation portion 9, and the second diaphragm 47 is bent and deformed. For that reason, it is possible to detect the impact based on the detected signal V2 output from the bridge circuit 60.

However, for example, the second diaphragm 47 is bent and deformed also by external force (hereinafter, also referred to as “unnecessary external force”) such as self-weight, acceleration, or atmospheric fluctuation, other than pressure and thus, a component of unnecessary external force is included in the detected signal V2 output from the bridge circuit 60, in addition to the impact. For that reason, it is unable to accurately detect the impact from the detected signal V2 output from the bridge circuit 60. Accordingly, in the sensor device 1, the first diaphragm 45 for measuring unnecessary external force acting on the second diaphragm 47 is provided.

The pressure propagation portion 9 is not provided on the pressure receiving surface 451 side of the first diaphragm 45 and thus, the impact is prevented from being transmitted to the first diaphragm 45 via the pressure propagation portion 9. The pressure receiving surface 451 of the first diaphragm 45 and the pressure receiving surface 471 of the second diaphragm 47 face the same space and thus, the first diaphragm 45 bends and deforms in the same manner as the second diaphragm 47 due to unnecessary external force. For that reason, the detected signal V1 in accordance with the unnecessary external force received by the first diaphragm 45 is output from the bridge circuit 50 and the detected signal V1 can be regarded as the unnecessary external force received by the second diaphragm 47. Accordingly, the correction unit 58 corrects the output (detected signal V2) of the differential pressure sensor 3 based on the output (detected signal V1) of the pressure sensor 2 so as to make it possible to cancel the component of unnecessary external force output from the differential pressure sensor 3 by using the corrected signal V3 and to detect the impact more accurately.

Such a sensor device 1 can exhibit effects more remarkably, for example, in an environment in which the sensor device 1 is brought into contact with a surrounding object such as a vehicle such as an automobile or an airplane, and a robot having a rotatable arm and easily receives impact.

The sensor device 1 according to the second embodiment has been described as above. The sensor device 1 described above includes the pressure sensor 2 including the first diaphragm 45, which is bent and deformed by pressure reception and of which an upper surface (one surface) is the pressure receiving surface 451, and the pressure reference chamber S positioned on a lower surface (surface opposite to the pressure receiving surface 451) side with respect to the first diaphragm 45 and measuring the pressure received by the pressure receiving surface 451, the differential pressure sensor 3 which includes the second diaphragm 47 which is bent and deformed by pressure reception and of which an upper surface (one surface) is the pressure receiving surface 471 (first pressure receiving surface) and a lower surface (the other surface) is the pressure receiving surface 472 (second pressure receiving surface) and detects differential pressure which is the difference between the pressure received by the pressure receiving surface 471 and the pressure received by the pressure receiving surface 472, and the correction unit 58 for correcting the output of one of the pressure sensor 2 and the differential pressure sensor 3 based on the output of the other of the pressure sensor 2 and the differential pressure sensor 3. In particular, in the second embodiment, the correction unit 58 is configured to correct the output (detected signal V2) of the differential pressure sensor 3 based on the output (detected signal V1) of the pressure sensor 2. With this, it is possible to cancel unnecessary external force such as acceleration, vibration, and atmospheric fluctuation applied to the sensor device 1 and to detect impact more accurately. Accordingly, the sensor device 1 having excellent detection accuracy can be obtained.

Even with the second embodiment described above, it is possible to achieve the same effects as those of the first embodiment described above.

### Third Embodiment

Next, a sensor device according to a third embodiment of the invention will be described.

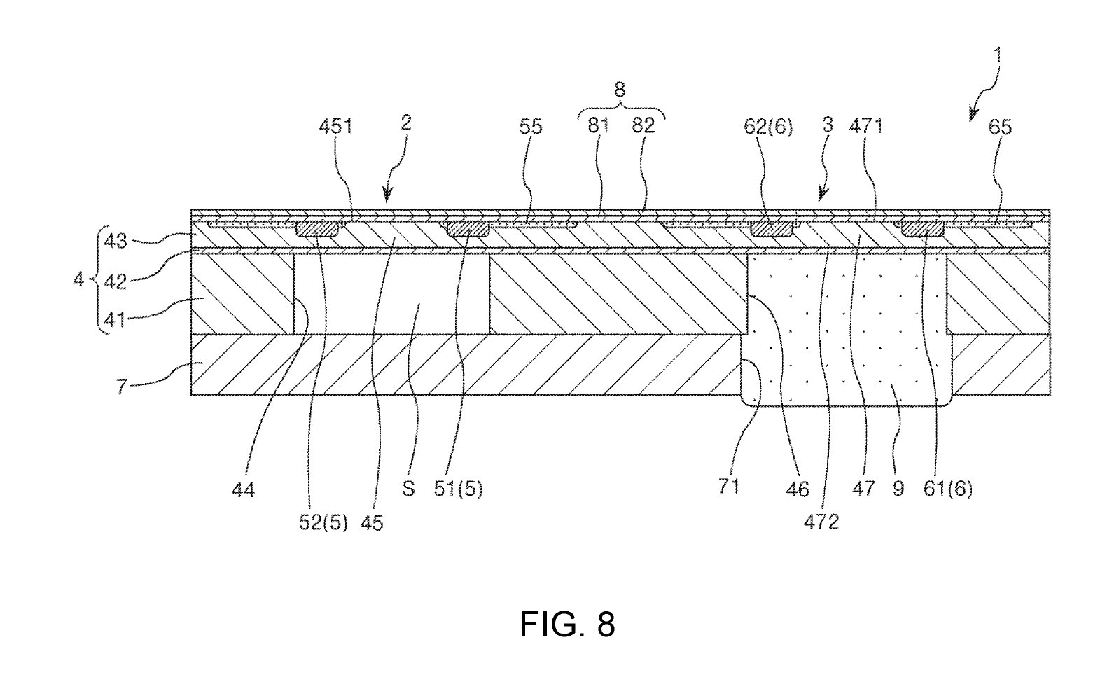

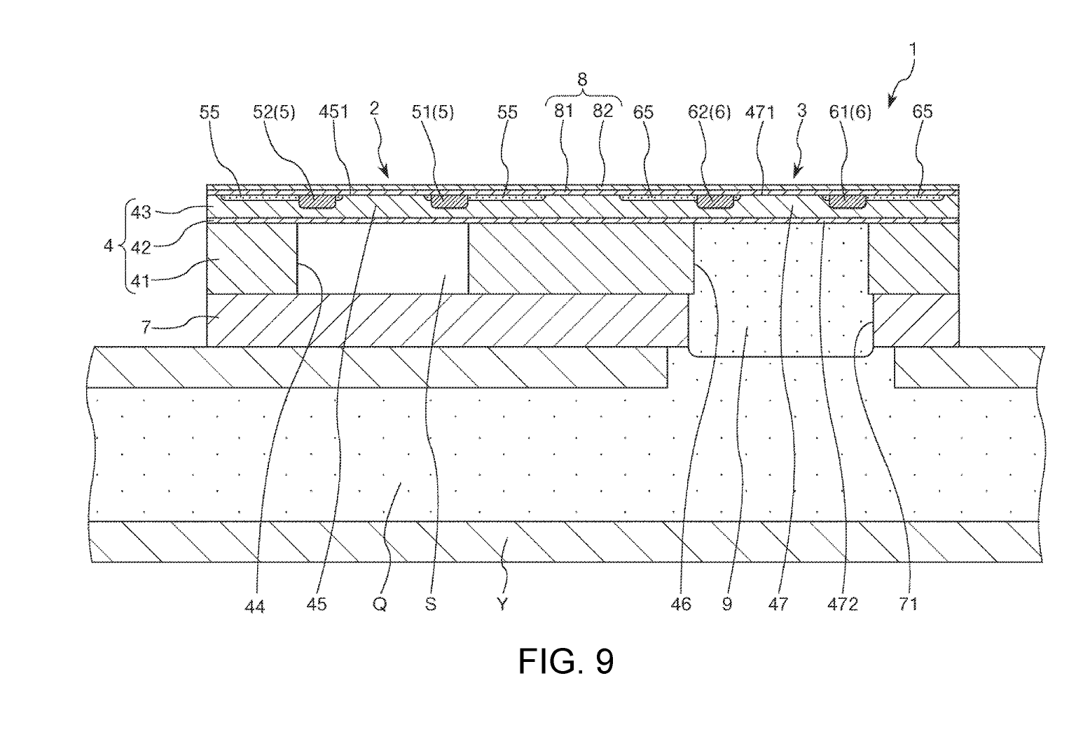

FIG. 8 is a cross-sectional view illustrating the sensor device according to the third embodiment of the invention. FIG. 9 is a cross-sectional view illustrating an attached state of the sensor device illustrated in FIG. 8.

In the following, description will be made mainly on the difference between the sensor device of the third embodiment and the embodiments described above, and the description of similar matters will be omitted.

The sensor device 1 according to the third embodiment of the invention is substantially the same as the first embodiment described above except that the configuration of the pressure propagation portion 9 is different. In FIG. 8 and FIG. 9, the same reference numerals are given to the same configurations as in the embodiments described above.

As illustrated in FIG. 8, in the sensor device 1 of the third embodiment, the pressure propagation portion 9 is disposed so as to cover the pressure receiving surface 472 of the second diaphragm 47 and so as not to cover the pressure receiving surface 451 of the first diaphragm 45 and the pressure receiving surface 471 of the second diaphragm 47. In the third embodiment, the pressure propagation portion 9 is filled in the recess portion 46. However, disposition of the pressure propagation portion 9 is not particularly limited, and may spread to, for example, the lower surface and the side surface of the sensor device 1. The constituent material of the pressure propagation portion 9 is not particularly limited, and for example, silicone oil, fluorine-based oil, silicone gel, grease, or the like can be used as the constituent material. However, the pressure propagation portion 9 may be omitted.

The sensor device 1 can be used as a differential pressure sensor that detects the difference (differential pressure) between the pressure received by the pressure receiving surface 471 and the pressure received by the pressure receiving surface 472. For example, as illustrated in FIG. 9, when the sensor device 1 is fixed to a flow path Y in such a way that the pressure receiving surface 472 faces the inside of the flow path Y and the pressure receiving surfaces 451 and 471 face the outside of the flow path Y, pressure of fluid Q (liquid, gas, or the like) flowing in the flow path Y is transmitted to the pressure receiving surface 472 via the pressure propagation portion 9 and the second diaphragm 47 is bent and deformed. For that reason, it is possible to detect the differential pressure inside and outside the flow path Y based on the detected signal output from the bridge circuit 60.

However, for example, the second diaphragm 47 is bent and deformed also by external force (hereinafter, also referred to as “unnecessary external force”) such as a self-weight, acceleration, or atmospheric fluctuation, other than the pressure and thus, the component of unnecessary external force is included in the detected signal output from the bridge circuit 60, in addition to the pressure of the fluid Q. For that reason, it is unable to accurately detect the differential pressure inside and outside the flow path Y by the detected signal output from the bridge circuit 60. Accordingly, in the sensor device 1, the first diaphragm 45 for measuring unnecessary external force acting on the second diaphragm 47 is provided.

The first diaphragm 45 does not face the flow path Y and thus, the pressure of the fluid Q is not transmitted to the first diaphragm 45. The pressure receiving surface 451 of the first diaphragm 45 and the pressure receiving surface 471 of the second diaphragm 47 face the same space and thus, the first diaphragm 45 bends and deforms in the same manner as the second diaphragm 47 due to unnecessary external force. For that reason, a detected signal in accordance with the unnecessary external force received by the first diaphragm 45 is output from the bridge circuit 50 and the detected signal can be regarded as unnecessary external force received by the second diaphragm 47. Accordingly, the sensor device 1 corrects an output (detected signal) of the differential pressure sensor 3 based on the output (detected signal) of the pressure sensor 2 so as to make it possible to cancel the unnecessary external force component from the output of the differential pressure sensor 3 and to detect the differential pressure inside and outside the flow path Y more accurately.

Such a sensor device 1 can exhibit effects more remarkably, for example, in an environment in which a vehicle such as an automobile or an airplane, or a robot having a rotatable arm, is used where a posture (inclination with respect to the vertical direction) of the sensor device 1 is liable to change and the sensor device 1 is susceptible to acceleration and vibration.

The sensor device 1 according to the third embodiment has been described as above. The sensor device 1 described above includes the pressure sensor 2 including the first diaphragm 45, which is bent and deformed by pressure reception and of which an upper surface (one surface) is the pressure receiving surface 451, and the pressure reference chamber S positioned on a lower surface (surface opposite to the pressure receiving surface 451) side with respect to the first diaphragm and measuring the pressure received by the pressure receiving surface 451 and the differential pressure sensor 3 which includes the second diaphragm 47 which is bent and deformed by pressure reception and of which an upper surface (one surface) is the pressure receiving surface 471 (first pressure receiving surface) and a lower surface (the other surface) is the pressure receiving surface 472 (second pressure receiving surface) and detects differential pressure which is the difference between the pressure received by the pressure receiving surface 471 and the pressure received by the pressure receiving surface 472. The sensor device 1 is configured in such a way that the output of one of the pressure sensor 2 and the differential pressure sensor 3 is corrected based on the output of the other of the pressure sensor 2 and the differential pressure sensor 3. In particular, in the third embodiment, the configuration in which the output of the differential pressure sensor 3 is corrected based on the output of the pressure sensor 2 is adopted. With this, it is possible to cancel the unnecessary external force such as acceleration, vibration, and atmospheric fluctuation applied to the sensor device 1 and to detect the differential pressure more accurately. Accordingly, the sensor device 1 having excellent detection accuracy can be obtained.

According to the third embodiment as described above, it is also possible to achieve the same effects as those of the above-described first embodiment.

### Fourth Embodiment

Next, an electronic apparatus according to a fourth embodiment of the invention will be described.

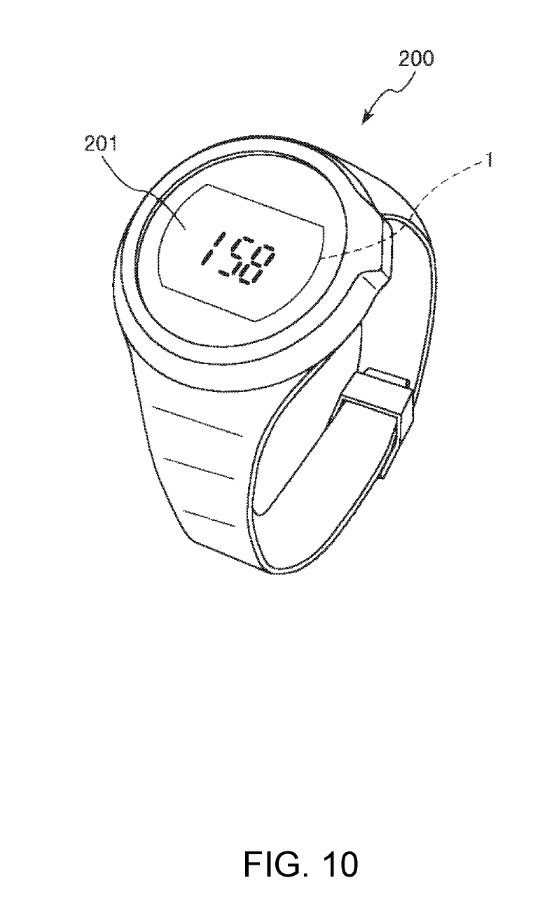

FIG. 10 is a perspective view illustrating an altimeter as the electronic apparatus according to the fourth embodiment of the invention.

As illustrated in FIG. 10, an altimeter 200 as an electronic apparatus can be worn on the wrist like a wrist watch. The sensor device 1 is mounted inside the altimeter 200 in which an altitude from sea level of the present location, atmospheric pressure of the present location, or the like can be displayed on a display unit 201. In the display unit 201, various pieces of information such as the current time, heart rate of a user, and weather, can be displayed.

The altimeter 200 which is an example of such an electronic apparatus includes the sensor device 1. For that reason, the altimeter 200 can obtain the effect of the sensor device 1 described above and can exhibit high reliability.

### Fifth Embodiment

Next, an electronic apparatus according to a fifth embodiment of the invention will be described.

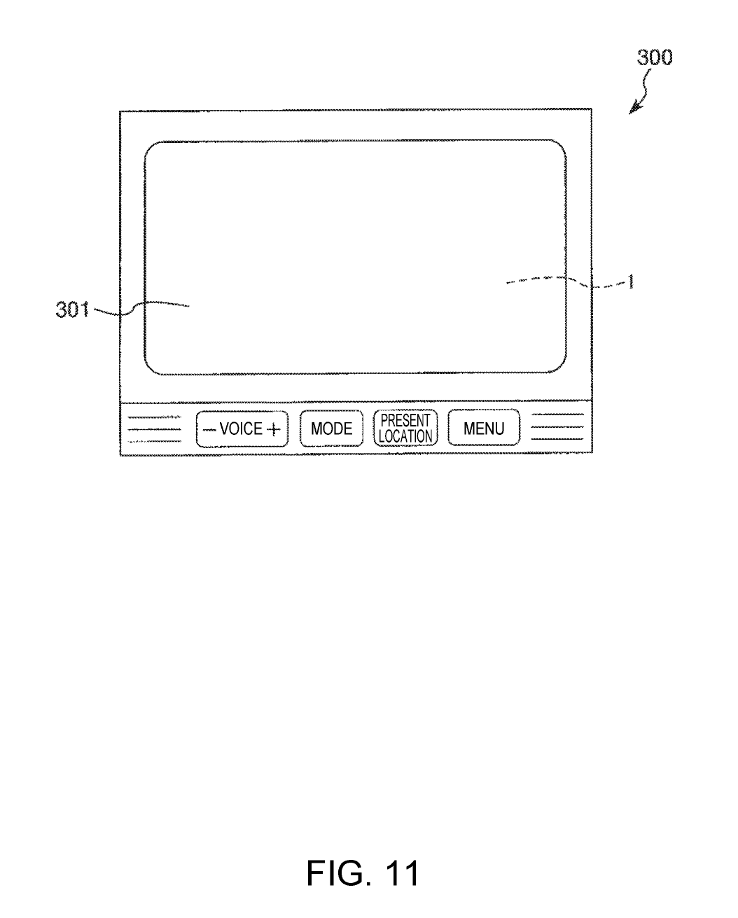

FIG. 11 is a front view illustrating a navigation system as the electronic apparatus according to the fifth embodiment of the invention.

As illustrated in FIG. 11, a navigation system 300 as an electronic apparatus includes a position information acquisition unit acquiring map information (not illustrated) and position information from a global positioning system (GPS), an autonomous navigation unit configured with a gyro sensor, an acceleration sensor, and automobile speed data, the sensor device 1, and a display unit 301 for displaying predetermined position information or course information.

According to the navigation system 300, altitude information can be acquired in addition to acquired position information. For example, when the automobile is traveling on an elevated road for which a position that is substantially the same as a general road in terms of position information is illustrated, in the case of not having altitude information, the navigation system does not determine whether the automobile is traveling on the general road or on the elevated road, and provides general road information to the user as priority information. Accordingly, the sensor device 1 is installed in the navigation system 300 and altitude information is acquired by the sensor device 1, so that altitude change due to entering the elevated road from the general road can be detected and navigation information can be provided to the user in the traveling state of the elevated road.

The navigation system 300 as an example of such an electronic apparatus has the sensor device 1. For that reason, the navigation system 300 can obtain the effect of the sensor device 1 described above and can exhibit high reliability.

The electronic apparatus according to the invention is not limited to the altimeter and the navigation system as described above, but may be applied to a personal computer, a digital still camera, a mobile phone, a smart phone, a tablet terminal, a watch (including smart watch), a drone, a medical instrument (for example, electronic clinical thermometer, blood pressure monitor, blood glucose meter, electrocardiogram measuring device, ultrasonic diagnostic device, electronic endoscope), various measuring instruments, instruments (for example, instruments of an automobile, aircraft, and ship), a flight simulator, and the like.

### Sixth Embodiment

Next, a vehicle according to a sixth embodiment of the invention will be described.

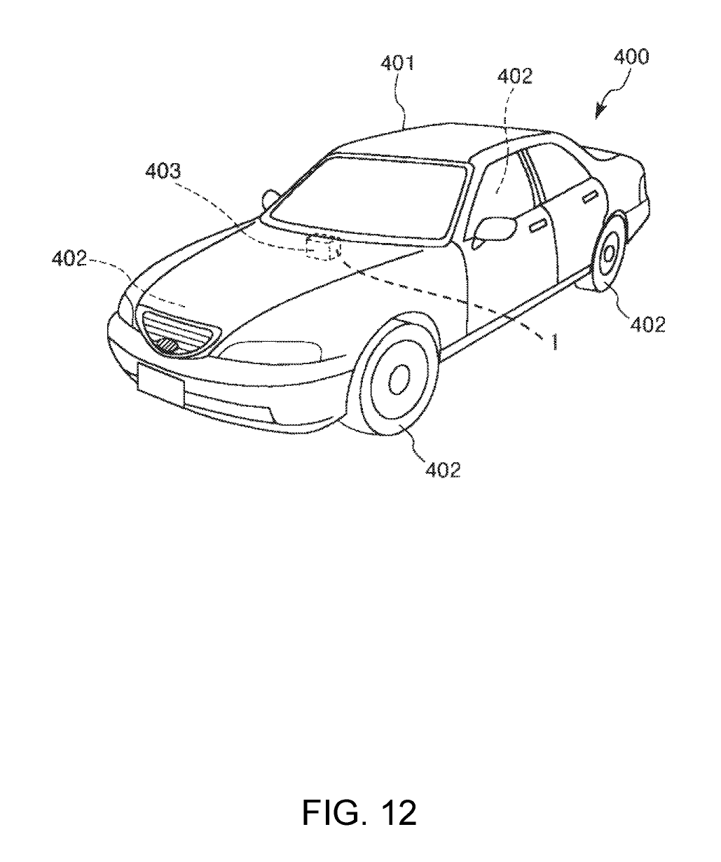

FIG. 12 is a perspective view illustrating an automobile as the vehicle according to the sixth embodiment of the invention.

As illustrated in FIG. 12, an automobile 400 as a vehicle has an automobile body 401 and four wheels 402 (tires), and is configured to rotate the wheels 402 by a power source (engine) (not illustrated) provided in the automobile body 401. The automobile 400 has an electronic control unit (ECU) 403 mounted on the automobile body 401, and the sensor device 1 is built in the electronic control unit 403. In the electronic control unit 403, the sensor device 1 detects acceleration, inclination, and the like of the automobile body 401 so that a moving state, a posture, and the like can be grasped and the wheels 402 and the like can be accurately controlled. With this, the automobile 400 can safely and stably move. The sensor device 1 may be mounted in a navigation system or the like provided in the automobile 400.

The automobile 400 as an example of such a vehicle has the sensor device 1. For that reason, the automobile 400 can obtain the effect of the sensor device 1 described above and can exhibit high reliability.

Although the sensor device, the electronic apparatus, and the vehicle according to the invention have been described based on the respective embodiments illustrated in the drawings, the invention is not limited thereto. The configuration of each unit can be replaced with an arbitrary configuration having the same function. Other arbitrary components and processes may be added. Also, respective embodiments may be appropriately combined.

In the embodiments described above, although the configuration in which the first diaphragm and the second diaphragm are oriented in the same direction has been described, the configuration is not particularly limited. A configuration in which the first diaphragm and the second diaphragm are oriented in different directions may be available. Further, in the embodiments described above, the configuration in which the first diaphragm and the second diaphragm are formed from the same substrate is described, but the invention is not limited thereto. A configuration in which the first diaphragm and the second diaphragm are formed from different substrates may be available. That is, the pressure sensor and the differential pressure sensor may be separately configured.

The entire disclosure of Japanese Patent Application No. 2017-062674, filed Mar. 28, 2017 is expressly incorporated by reference herein.

What is claimed is:

1. A sensor device comprising:
a pressure sensor including a first diaphragm which is bent and deformed by pressure reception and of which one surface is a pressure receiving surface and a pressure reference chamber which is positioned on a side opposite to the pressure receiving surface with respect to the first diaphragm, and measuring pressure received by the pressure receiving surface;
a differential pressure sensor including a second diaphragm which is bent and deformed by pressure reception and of which one surface is a first pressure receiving surface and the other surface is a second pressure receiving surface, and measuring differential pressure which is a difference between pressure received by the first pressure receiving surface and pressure received by the second pressure receiving surface; and
a correction unit correcting an output of one of the pressure sensor and the differential pressure sensor based on an output of the other of the pressure sensor and the differential pressure sensor.

2. The sensor device according to claim 1,
wherein the correction unit corrects the output of the pressure sensor based on the output of the differential pressure sensor.

3. The sensor device according to claim 1,
wherein the correction unit corrects the output of the differential pressure sensor based on the output of the pressure sensor.

4. The sensor device according to claim 1,
wherein the first diaphragm and the second diaphragm are oriented in the same direction.

5. The sensor device according to claim 1, further comprising;
a substrate,
wherein the first diaphragm and the second diaphragm are provided on the substrate.

6. The sensor device according to claim 1, further comprising;
a pressure propagation portion that covers the first diaphragm and the second diaphragm.

7. An electronic apparatus comprising:
the sensor device according to claim 1.

8. A vehicle comprising:
the sensor device according to claim 1.
